(19) United States
(12) Patent Application Publication
(10) Pub. No.: US 2007/0070348 A1
(43) Pub. Date: Mar. 29, 2007

(54) Optical device and microscope comprising an optical device for the collinear combination of light beams of varying wavelengths

(76) Inventor: Volker Seyfried, Nussloch (DE)

Correspondence Address: SIMPSON & SIMPSON, PLLC, 5555 MAIN STREET, WILLIAMSVILLE, NY, 14221-5406, US

(21) Appl. No.: 10/567,679

(22) PCT Filed: Aug. 6, 2004
(86) PCT No.: PCT/EP04/51739

§ 371 Date: Oct. 18, 2006

(30) Foreign Application Priority Data
Aug. 14, 2003 (DE) 103 37 558.9

(51) Int. Cl. G01J 3/28

(52) U.S. Cl. 356/330

(57) ABSTRACT

The invention relates to an optical device containing a dispersive element and a projection lens, which define a splitting plane on which a location is assigned to each wavelength. A microstructures element is located on the splitting plane, the element guiding light beams, which emanate from different directions and are focused on the locations corresponding to their wavelengths, through the projection lens to the dispersive element, which combines the light beams in a collinear manner.

The present invention relates to an optical device which collinearly unites light beams, and a microscope having an optical device.

Typically, dichroic beam splitters are used in optics for uniting light beams of different wavelengths. A punctual light source for a laser scanning microscope and a method for coupling at least two lasers of different wavelengths into a laser scanning microscope are known from German Published Application DE 196 33 185 A1. The punctual light source is implemented modularly and contains a dichroic beam unifier, which unites the light of at least two laser light sources and couples it into an optical fiber leading to the microscope.

Arrangements based on dichroic beam splitters frequently have the disadvantage that the unification of light beams which have wavelengths close to one another is possible not at all or only at a low efficiency, since dichroic beam unifiers having an infinitely steep edge characteristic are only theoretically producible.

A beam unification device for semiconductor lasers, which contains both dichroic mirrors and also a polarizing beam splitter prism, is known from European Patent Specification EP 0 473 071 B1. With the aid of the polarizing beam splitter prism, light beams which have polarization directions perpendicular to one another may be unified into a collinear light beam, this having both polarization directions. This method for producing a new illumination light beam from two individual light beams may only be used in a restricted way for microscopy, since the predefined polarization characteristic of the resulting illumination light beam often restricts the experimental conditions too much.

In scanning microscopy, a sample is illuminated with a light beam in order to observe the reflection or fluorescence light emitted by the sample. The focus of an illumination light beam is moved in an object plane with the aid of a controllable beam deflection device, generally by tilting two mirrors, the deflection axes usually being perpendicular to one another, so that one mirror deflects in the x direction and the other in the y direction. The tilting of the mirrors is produced, for example, with the aid of galvanometer actuating elements. The power of the light coming from the object is measured as a function of the position of the scanning beam. The actuating elements are typically equipped with sensors to ascertain the current mirror position.

Especially in confocal scanning microscopy, an object is scanned in three dimensions using the focus of a light beam.

A confocal scanning microscope generally comprises a light source, an imaging optic, using which the light of the source is focused on a pin diaphragm (the excitation diaphragm), a beam splitter, a beam deflection device for beam control, a microscope optic, a detection screen and the detectors for detecting the detection and/or fluorescence light. The illumination light is often coupled in via the beam splitter, which may be implemented as a neutral beam splitter or as a dichroic beam splitter, for example. Neutral beam splitters have the disadvantage that much excitation light or much detection light is lost depending on the splitting ratio.

The fluorescence or reflection light coming from the object returns to the beam splitter via the beam deflection device, and passes it in order to subsequently be focused on the detection screen, behind which the detectors are located. Detection light which does not originate directly from the focal region takes another light path and does not pass the detection screen, so that punctual information is obtained which results in a three-dimensional image through sequential scanning of the object. Usually, a three-dimensional image is achieved through layered image data recording, the path of the scanning light beam on and/or in the object ideally describing a meandering path (scanning one line in the x direction with constant y position, subsequently stopping x scanning and pivoting to the next line to be scanned via y adjustment and then, at constant y position, scanning this line in the negative x direction, etc.). In order to allow a layered image data recording, the sample table or the objective is shifted after the scanning of a layer and the next layer to be scanned is thus brought into the focal plane of the objective.

In many applications, samples having multiple markers, such as multiple different fluorescent pigments, are prepared. These pigments may be excited sequentially, for example, using illumination light beams which have different excitation wavelengths. Simultaneous excitation using an illumination light beam which contains the light of multiple excitation wavelengths is also typical. For example, an arrangement having a laser emitting multiple individual laser lines is known from European Patent Application EP 0 495 930: “confocal microscope system for multicolor fluorescence.” Currently, such lasers are usually implemented as mixed gas lasers, particularly as ArKr lasers, in practice.

A device for the adjustable coupling and/or detection of one or more wavelengths in a microscope is known from German Published Application DE 198 42 288 A1.

It is the object of the present invention to specify an optical device which allows light beams to be collinearly united independently of the polarization direction and independently of the spectral proximity of the wavelengths.

This object is achieved by an optical device in which a dispersive element and an imaging optic define a cleavage plane, in which each light wavelength is assigned a location and in which a microstructured element is positioned, which deflects the light beams, which come from different directions and are focused on locations corresponding to their wavelengths, via the imaging optic to the dispersive element, which collinearly unites the light beams.

The present invention has the advantage that light beams which contain a continuous spectrum may also be united; even if wavelengths of one light beam lie within the spectrum of the other light beam.

If one of the light beams contains light of multiple wavelengths, this light beam is spectrally cleaved spatially before being incident on the microstructured element. This may be performed using a further dispersive element, for example, using a prism or a grating, or using a dispersive element which unites the light originating from the microstructured element.

The dispersive element may be implemented as a grating or as a prism, for example. The imaging optic may be implemented as a lens optic or as a mirror optic, for example. In a special variation, the dispersive element and the imaging optic are combined as a concave mirror grating, for example. The imaging optic may contain both cylindrical and also spherical optics.

Preferably, the distance between the dispersive element and the imaging optic and, in addition, the distance between the imaging optic and the microstructured element corresponds to the focal length f of the imaging optic. If the imaging optic, which is implemented as a lens, for example, has two different main planes, or if a lens combination is preferred for any reason, the distances are preferably selected accordingly, so that the imaging of the different wavelengths is performed telecentrically on the cleavage plane. The imaging optic is preferably a telecentric imaging system, since then no parallel offset of the returning light occurs.

In a special variation, the microstructured element has reflecting and transmitting areas. The light of a first light beam is focused on the reflecting areas in this variation, while the light of a second light beam is focused on the transmitting areas. The microstructured element may, for example, contain a photolithographic partially mirrored glass substrate, to which the reflecting in the transmitting areas are applied in strips. The strip pattern preferably runs perpendicularly to the cleavage direction of the dispersive element.

In another embodiment, the microstructured element has mirror surfaces of different inclinations. Preferably, a lamellar structure made of linear, for example, rectangular planar areas, each of which is mirrored and inclined in a different spatial direction, is used, the line direction running perpendicular to the spectral cleavage in the cleavage plane. The particular planar surface parts are preferably rotated out of the cleavage plane around an axis of rotation lying in the cleavage plane, the axis of rotation advantageously running perpendicularly to the direction of the spectral cleavage. In another variation, the planar surface parts are rotated out of the cleavage plane around axes of rotation running parallel to the cleavage direction. The microstructured element may comprise a correspondingly processed and mirrored glass material. In a preferred embodiment, the microstructured element contains a micro-electromechanical system (MEMS) and/or a micro-optoelectromechanical system (MOEMS). A microstructured element implemented in this way has the additional advantage that the local reflection angle may be changed by applying voltages. A usable MDM mirror array is produced by Texas Instruments, for example.

In another preferred embodiment, the microstructured element contains a microprism array made of different prisms or an array having zones which have different indices of refraction, which could be implemented through suitably polarized lithium niobate in an electrical field, for example. In addition, this variation allows specific activation via the electrical field.

The beam uniting technology according to the present invention may be combined with other beam uniting technologies, i.e., beams which have already been united in the foreground may be united with further beams, for example.

All parts to be moved during the adjustment are preferably motorized, in particular, it may be advantageous if the spectrally selective element is movable along the direction of the spectral cleavage.

Elements which vary the light power may be positioned before or after the optical device according to the present invention, e.g., preferably an AOTF. The optical device is preferably manufactured as a mechanical unit, which may contain further components such as an AOTF or a temperature stabilizer, for example.

It is possible using the technology described to thread not only a second light beam, but rather also a third or further light beams, on a first light beam. This is possible especially advantageously in connection with the MEMS/MOEMS actuators described.

In a very especially preferred embodiment, the optical device is used for generating an illumination light beam in a scanning microscope, particularly in a confocal scanning microscope.

The object of the present invention is schematically illustrated in the drawing and will be described in the following on the basis of the figures, identically acting components being provided with the same reference numbers.

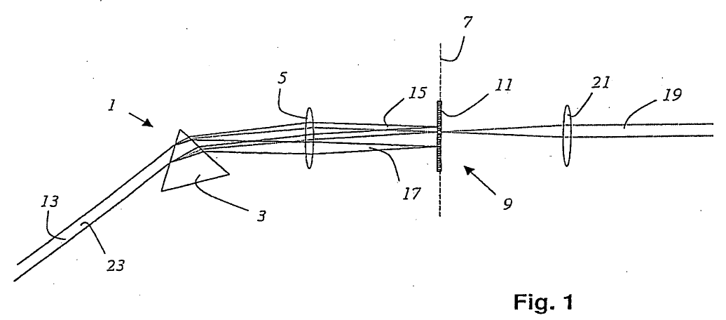

FIG. 1 shows an optical device according to the present invention,

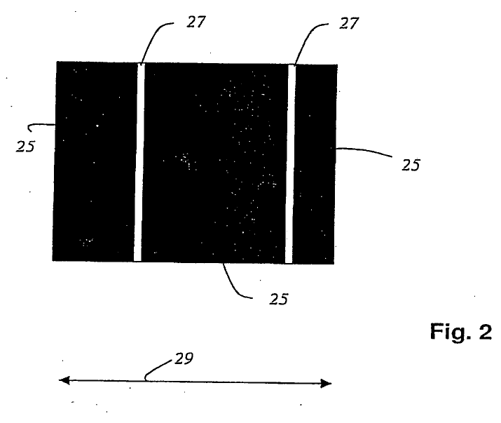

FIG. 2 shows a microstructured element,

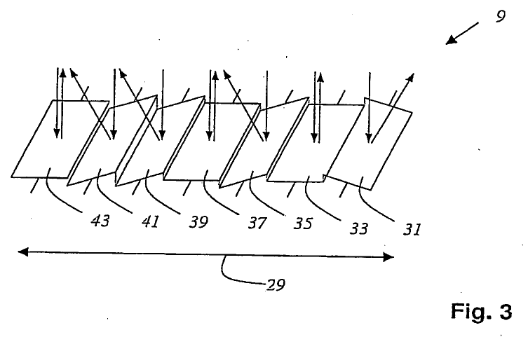

FIG. 3 shows a further microstructured element,

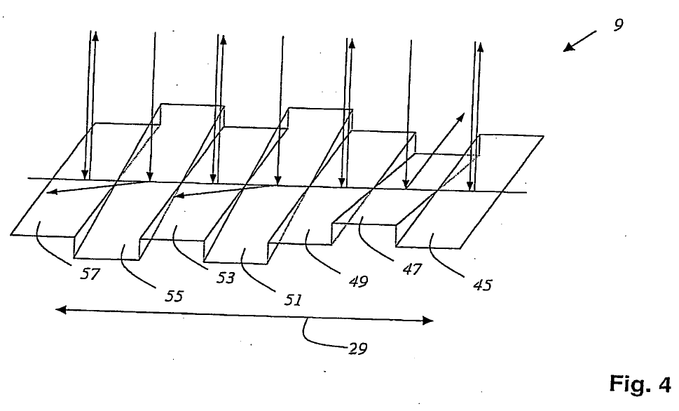

FIG. 4 shows a further microstructured element,

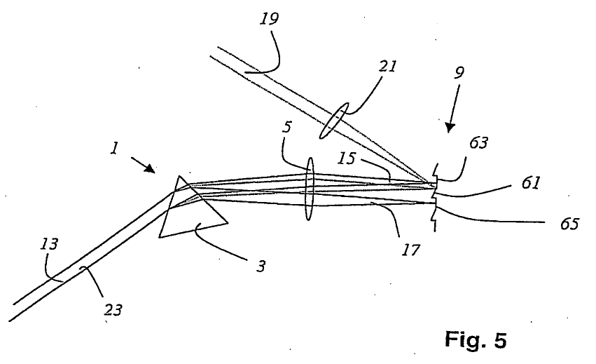

FIG. 5 shows a further optical device according to the present invention, and

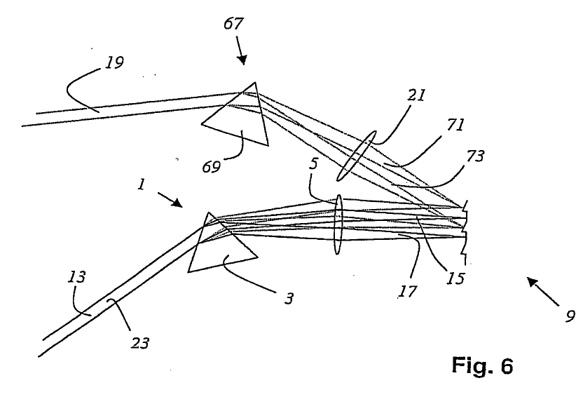

FIG. 6 shows another optical device according to the present invention.

FIG. 1 shows an optical device according to the present invention having a dispersive element 1, which is implemented as a prism 3, and having an imaging optic 5, which jointly define a cleavage plane 7, in which a microstructured element 9 is positioned. The microstructured element 9 is implemented as a glass substrate 11 reflecting in strips, the strips of the strip pattern being oriented perpendicularly to the cleavage direction of the prism 3. A first light beam 13, which contains the light of two wavelengths, is spectrally cleaved spatially by the prism 3 and the resulting partial beams 15, 17 are focused by the lens 5 on a mirrored strip of the glass substrate 11 in each case. A second light beam 19 is focused by an optic 21 on a transmitting strip of the glass substrate 11. The locations at which the partial beams 15, 17 and the second light beam 19 are incident on the glass substrate 11 correspond to their wavelengths in accordance with the cleavage characteristic of the prism 3. The partial beams 15, 17 reflected by the glass substrate 11 are guided together with the transmitting second light beam 19 via the lens 5 to the prism 3, which unites the partial beams 15, 17 and the second light beam 19 collinearly into an output light beam 23. The microstructured element 9 has a slight inclination in relation to the optical axis in order to spatially separate the first light beam 13 and the output light beam 23 from one another. Due to the inclination of the microstructured element 9, the output light beam 23 runs at an acute angle out of the plane of the drawing, which is not recognizable in the figure. The inclination only influences the mode of operation of the optical device very slightly, however.

FIG. 2 shows the microstructured element 9 which has already been cited in regard to FIG. 1. The microstructured element 9 is implemented as a glass substrate coated in strips and has areas 25 and transmitting areas 27. The strip pattern is, as indicated by the double arrow 29, positioned perpendicularly to the direction of the spectral cleavage of the dispersive element.

FIG. 3 shows a microstructured element 9 having planar mirror elements 31-43, which have different inclinations. The planar mirror elements 31-43 are rotatable around axes of rotation which lie perpendicular to the spectral cleavage direction in the cleavage plane. The microstructured element 9 is implemented as a micro-optoelectromechanical system (MOEMS), so that the particular angles of inclination are changeable by applying voltages.

FIG. 4 shows a microstructured element having microprisms 45-57. The prisms are inclined around an axis of rotation which runs parallel to the spectral cleavage direction.

FIG. 5 shows a further optical device according to the present invention, which contains a completely reflecting microstructured element 9, which has a lamellar structure 59. The first light beam 13 is incident on the microstructured element 9, as already described with reference to FIG. 1. The second light beam 19 is focused by the lens 21 on a first part of the microstructured element. The partial beams 15, 17 are incident on other parts 63, 65, the parts 63, 65 having a different inclination than the part 61. The inclinations of the parts 61-65 are selected in such a way that the partial beams 15, 17 and the second light beam 19 are deflected jointly via the lens 5 to the prism 3, which unites the partial beams 15, 17 and the second light beam 19 collinearly into an output light beam 23.

FIG. 6 shows a refinement of the optical device shown in FIG. 5. In this embodiment variation, the second light beam 19 contains light of multiple wavelengths and is spectrally cleaved spatially into the partial beams 71 and 73, which are focused by the lens 21 on different locations of the microstructured element 9, by an element 67, which is implemented as a further prism 69. The microstructured element 9 reflects the partial beams 15, 17 and the partial beams 71, 73 jointly via the lens 5 to the prism 3, which unites the partial beams 15, 17, 71, 73 into a collinearly united output light beam 23.

The present invention was described in reference to a special embodiment. However, it is obvious that changes and alterations may be performed without leaving the protective scope of the following claims.

### LIST OF REFERENCE NUMBERS

1 dispersive element
3 prism
5 imaging optic
7 cleavage plane
9 microstructured element
11 glass substrate
13 first light beam
15 partial beam
17 partial beam
19 second light beam
21 optic
23 output light beam
25 mirrored areas
27 transmitting areas
29 direction of the spectral cleavage
31-43 mirror elements
45-57 microprisms
59 lamellar structure
61 part
63 part
65 part
67 further dispersive element
69 further prism
71 partial beam
73 partial beam

1. An optical device comprising:
a dispersive element operatively arranged to split a first light beam from a first direction into various wavelengths;
an imaging optic and,
a microstructured element operatively arranged at a cleavage plane, wherein said cleavage plane is defined by said dispersive element and said imaging optic, said cleavage plane defining a position for said various wavelengths, wherein said microstructured element is operatively arranged to deflect said first light beam from said first direction and at least a second light beam from a second direction, said light beams focused via said imaging optic on positions corresponding to their respective wavelength and to said dispersive element, wherein said dispersive element is operatively arranged to collinearly unite said light beams.

2. The optical device according to claim 1, wherein the light beams have different wavelengths.

3. The optical device according to claim 1, wherein at least one light beam has multiple wavelengths.

4. The optical device according to claim 1, wherein the dispersive element comprises means for spectrally cleaving at least one light beam spatially before the incidence on the microstructured element.

5. The optical device according to claim 1, wherein at least one further dispersive element spectrally cleaves at least one light beam spatially before the incidence on the microstructured element.

6. The optical device according to claim 1, wherein the dispersive element comprises a prism.

7. The optical device according to claim 1, wherein the dispersive element comprises a grating.

8. The optical device according to claim 1, wherein the dispersive element comprises the imaging optic.

9. The optical device according to claim 1, wherein the microstructured element comprises reflecting and transmitting areas.

10. The optical device according to claim 9, wherein the reflecting areas of the microstructured element comprise mirrored surfaces of different inclinations.

11. The optical device according to claim 1, wherein the microstructured element comprise MEMS (micro-electromechanical systems) and/or MOEMS (micro-optoelectromechanical systems).

12. The optical device according to claim 1, wherein the microstructured element comprises a micromirror array.

13. The optical device according to claim 1, wherein the microstructured element comprises a microprism array.

14. The optical device according to claim 1, wherein the microstructured element comprises areas having varying indices of refraction.

15. A microscope comprising an optical device according to claim 1.

16. A scanning microscope, which comprises, an optical device for generating an illumination light beam according to claim 1.

17. The scanning microscope according to claim 16, which is a confocal scanning microscope.

18. A microscope comprising an optical device according to claim 6.

19. A microscope comprising an optical device according to claim 7.

20. A microscope comprising an optical device according to claim 8.

21. A microscope comprising an optical device according to claim 11.

22. A microscope comprising an optical device according to claim 12.

23. A microscope comprising an optical device according to claim 13.
